(19) United States
(12) Patent Application Publication
(10) Pub. No.: US 2004/0118255 A1
(43) Pub. Date: Jun. 24, 2004

(54) Saw guard

(76) Inventor: Bryan Glenn Peters, Winnipeg (CA)

Correspondence Address: Clifford W. Browning, Woodard, Emhardt, Naughton, Moriarty & McNett, Bank One Center/Tower, 111 Monument Circle, Suite 3700, Indianapolis, IN, 46204-5137, US

(21) Appl. No.: 10/327,830

(22) Filed: Dec. 23, 2002

(51) Int. Cl. B26D 1/00; B26D 3/00; B26D 1/18; B27B 3/28; B23D 19/00; B27B 27/04

(52) U.S. Cl. 83/13; 83/477.2

(57) ABSTRACT

A guard for a table saw has a cover member positioned above a working surface and rotating blade of a table saw. The cover member provides a gap between a lower surface of the cover member and the working surface to permit a work piece to pass there through to be cut by the rotating blade. The guard has at least one support member for supporting the cover member above the working surface. The support member facilitates lateral movement of the cover member between a first position and a second working position. The lateral movement is generally parallel to the working surface. The cover member covers the rotating blade from above throughout the cutting operation.

### FIELD OF THE INVENTION

The present invention relates to guards for table saws.

### BACKGROUND OF THE INVENTION

One of the gravest dangers faced by operators of table saws is the accidental dismemberment of the fingers or hands of an operator using a table saw to make cuts on a work piece. This problem of accidental dismemberment is of particular concern in situations where the table saw is used for industrial purposes, in part because of the increased risk of such accidents happening due to the fatigue experienced by operators spending long hours using the table saw, and in part because of the higher degree of finesse needed when making complicated cuts for the wood product being manufactured. Another problem faced by operators of tables saws, be it saws that are used for industrial purposes, or saws that are used for personal or home uses, is that of wood chips and debris being propelled at high velocities as a result of the contact between the wood material and table saw. Such flying debris can cause serious injury, such as for example if it strikes the eye of the operator. Of course, even lesser injuries, such as abrasions and cuts, are a cause for concern.

The typical solution for protecting against accidental dismemberment of fingers and hands, and to prevent the scattering of wood debris, is to use a saw guard that is positioned proximate to the blade of the table saw. Guards for table saws are known in the art. However, a common problem experienced with known saw guards is that they are positioned in such a way that they obstruct the view operators have of the table saw particularly as a cut is being made. Additionally, some known guards also partially obstruct certain angles of approach to the saw blade, thereby making certain wood cuts difficult to make.

To overcome the obstruction problem inherent in the use of saw guards, some saw guard designs have been proposed in which the saw guard can be moved away from its protecting position to a position where the blade becomes exposed. This allows the operator to make cuts that would otherwise be difficult, if not impossible, to make had the guard remained in its resting position. For example, U.S. Pat. No. 5,181,447 issued to Hewitt describes a guard apparatus suspended from a superstructure. The guard apparatus consists of several position adjustment mechanisms that allow the operator to pivot the guard apparatus upwards and away from the saw blade in order to make difficult cuts. However, the re-positioning mechanism employed by the guard apparatus is somewhat cumbersome, and requires careful manipulation of the various positioning mechanisms. Additionally, when the blade becomes exposed, the operator again is somewhat vulnerable to accidental injuries that may be caused by the saw blade.

Another movable saw guard design is that described in U.S. Pat. No. 5,231,906 issued to Kogej. The patent discloses a saw guard consisting of a shell shaped guard that in its resting position covers the saw blade entirely. The guard is mounted on a post and can slide vertically along it. The post is placed adjacent to the saw blade. When a wood board is pushed towards the blade, the board nudges the saw guard upwardly, forcing the guard to be lifted above the blade, thereby exposing the blade, and permitting the cut to be made. However, the presence of the post adjacent to the saw blade results in some obstruction that impedes, to some extent, the movement of wood material through the saw blade. Also, the guard covers the blade only when no cuts are being made, but does not cover the blade when wood materials are being cut, thus exposing the operator's hands to the blade.

Another guard design described by the prior art is the one described in U.S. Pat. No. 4,735,245 issued to Cox. That saw guard disclosed in the Cox patent consists of an elongated support arm and a guard portion made of an end wall, that prevents any contact with the saw blade, and a wedge shaped extension attached to the end-wall. The guard portion is attached to the support arm through a bolt, and can vertically pivot about the support arm. When a piece of wood material is pushed towards the saw blade, the material comes in contact with the wedge-shaped part of the guard potion, and forces it upwards. This movement forms an opening between the wedge-shaped portion and the cutting surface of the table to allow the wood material to pass through and engage the saw blade. The problem with this saw guard design is that it is still necessary for an operator to guide the wood material as the material is being cut by the blade, effectively once again leaving the operators hands dangerously close to the saw blade.

Thus, while the prior art offers a variety of saw guards that can be moved away from their resting positions in which they cover the blades, those saw guards still require the operator to come close to the blade as the operator is guiding the wood material towards the saw blade, or create obstructions that make it difficult for the operator to make certain cuts.

Another problem with current available saw guards, is that they are not designed for easy and efficient use with push sticks. In order to avoid approaching too closely the moving saw blade of the table saw while cutting wood materials, operators often use a push stick to direct the wood material towards the blade. Unfortunately, most existing saw guide designs, particularly movable saw guards, are not designed to accommodate a push stick, effectively blocking the movement of the push stick or creating other obstructions that make it difficult to use a push stick.

### SUMMARY OF INVENTION

It is therefore desirable to provide for an improved movable table saw guard.

According to one aspect of the present invention, there is provided a guard for a table saw that comprises a table having an upper working surface and a rotating blade mounted to the table and configured to cut a work piece that is moved past it on the working surface. The guard is comprised of a cover member positioned above the working surface and the rotating blade. The cover member provides a gap between a lower surface of the cover member and the working surface to permit a work piece to pass there through to be cut by the rotating blade. The guard is also comprised of at least one support member for supporting the cover member in the position. At least one support member is adapted to facilitate lateral movement of the cover member between a first position and a second working position. The lateral movement is generally parallel to the working surface and the movement is between a first position wherein the cover member covers the rotating blade from above and blocks a pushing member from passing the cover member, and a second position wherein the cover member no longer blocks the pushing member from passing the cover member wherein the cover member still covers the rotating blade from above, in the second position.

According to another aspect of the present invention, there is provided a table saw including a table having an upper working surface. A rotating blade is configured to cut a work piece that is moved past it on the working surface. A guard comprised of a cover member oriented generally parallel to the working surface of the table and being positioned above the working surface and the rotating blade. The cover member provides a gap between a lower surface of the cover member and the working surface to permit a work piece to pass there through to be cut by the rotating blade. At least one support member supports the cover member in the position. At least one support member is adapted to facilitate lateral movement of the cover member between a first position and a second position, the lateral movement is generally parallel to the working surface and the movement is between a first position wherein the cover member covers the rotating blade and blocks a pushing member from passing the cover member, and a second position wherein the cover plate no longer blocks the pushing member from passing between the cover member but at which the cover plate still covers the rotating blade.

According to another aspect of the present invention, there is provided a method for cutting materials using a table saw and using a saw guard. The saw guard is comprised of a substantially planar protective section positioned above the saw blade of the table saw, and of a retracting mechanism comprised of an arm attached to the protective section and a spring attached to the protective section and biased to return the protective section to the protective section's original position. The method is comprised of placing a piece of the material along a rip fence such that the material abuts the rip fence. The material is pushed along the rip fence towards the saw blade using a push stick. The push stick has a vertical height larger than the vertical distance between the protective section of the saw guard and the upper surface of the table saw. The protective section of the saw guard is engaged using the push stick, which causes the arm attached to the protective section to pivot laterally. This causes the protective section to be displaced away from the rip fence and forms a narrow gap between the protective section and the rip fence, while maintaining the protective section above the saw blade. The push stick slides in the gap formed between the protective section and the rip fence, and continues to push the material in the direction of the saw blade. Upon completion of the cut, the push stick is removed from the gap formed between the rip fence and the protective section of the saw guard. This allows the retracting mechanism to return the protective section to the protective section's original position.

According to another aspect of the present invention, there is provided a method for cutting materials using a table saw having a saw blade, and using a saw guard comprised of a protective member positioned above the saw blade of the table saw. The method is involves the step of placing a piece of the material along a longitudinally oriented guide member such that the material abuts the rip fence. The material is pushed longitudinally with a push stick along the guide member towards the saw blade. The protective member moves laterally while maintaining the protective member above the saw blade by longitudinal engagement of the push stick with an edge of the protective member. To permit the push stick to pass the protective member, the protective member covers the saw blade from above during the pushing by the push stick.

According to another aspect of the present invention, there is provided a guard for a table saw. The table saw is comprised of a table having an upper working surface and a rotating blade mounted to the table and configured to cut a work piece that is moved past it on the working surface. The guard is comprised of a cover plate positioned above and oriented generally parallel to the working surface. Being positioned above the rotating blade, the cover plate provides a gap between a lower surface of the cover plate and the working surface to permit a work piece to pass there through to be cut by the rotating blade. The guard also has at least one support member for supporting the cover plate in the position.

Various other features and advantages of the present invention will be evident from the following detailed description and accompanying drawings.

### BRIEF DESCRIPTION OF THE DRAWINGS

In drawings illustrating by way of example only, embodiments of the invention:

FIG. 1 is a top, front perspective view of a table saw employing a saw guard, in accordance with a preferred embodiment of the present invention;

FIG. 2 is a front elevation view of the table saw and saw guard of FIG. 1;

FIG. 3 is a top plan view of the table saw and saw guard of FIG. 1

FIGS. 3a and 3b are enlarged perspective and side views of part of the saw guard of FIG. 1, in isolation;

FIGS. 4 to 7 are top plan views of the table saw and saw guard of FIG. 1 shown in operational sequence;

FIG. 7a is a top plan view of the table saw and saw guard of FIG. 1, shown in an alternate operational configuration to that in FIGS. 4 to 7;

FIG. 8 shows the table saw and saw guard of FIG. 1 in another configuration; and

FIG. 9 shows a top, side perspective view of the table saw and saw guard, and a push stick used to push wood materials towards the saw blade.

### DETAILED DESCRIPTION

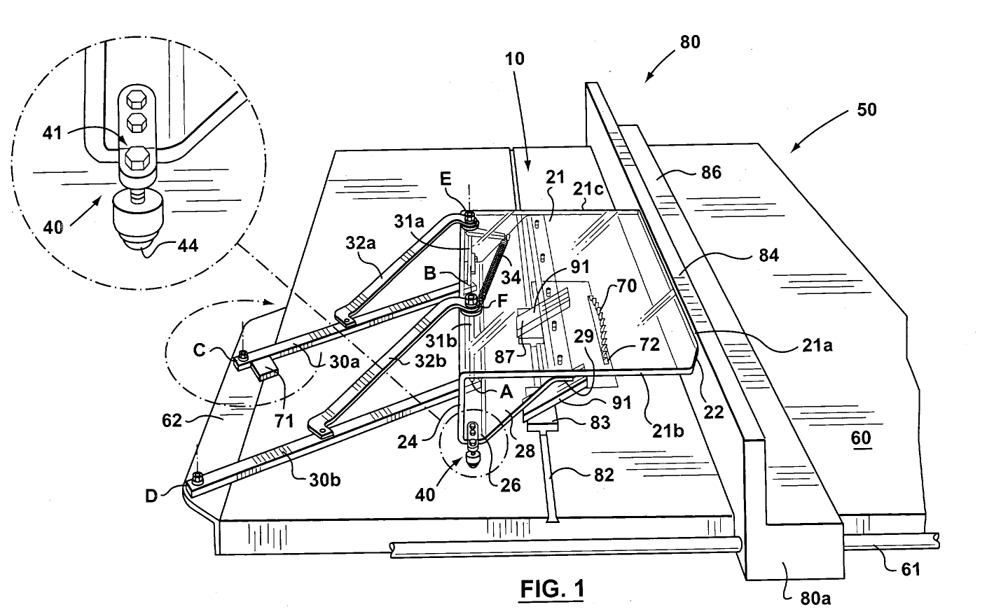

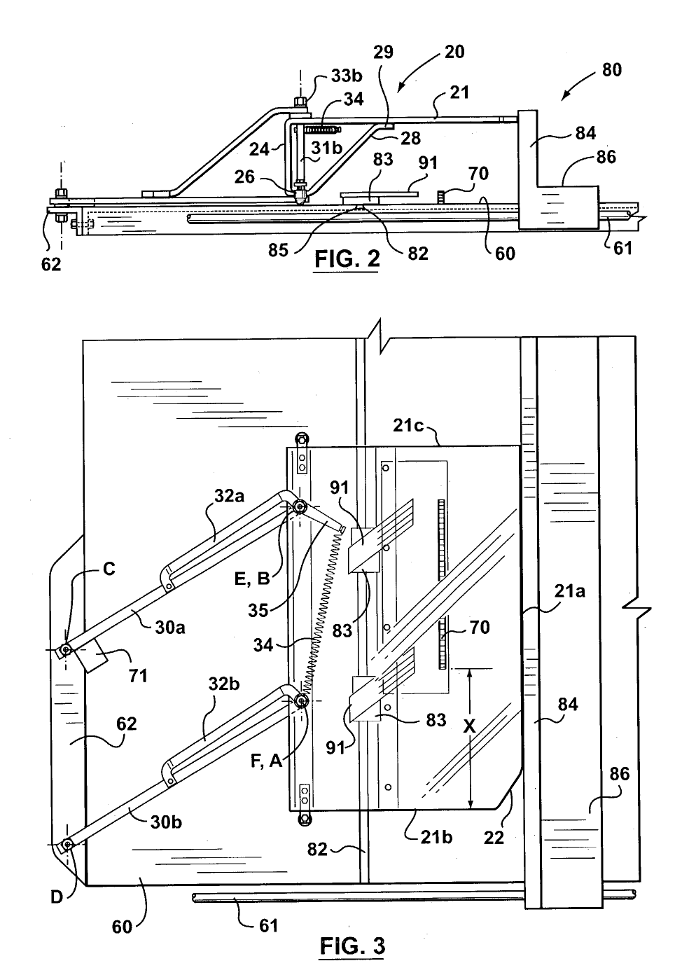

With reference to FIGS. 1, 2 and 3, a saw guard 10 is positioned above a rotating circular saw blade 70 that is part of a table saw 50. Table saw 50 is of known configuration and can be constructed like those commercially available table saws manufactured by companies such as Sears (eg. CRAFTSMAN brand), Hitachi, Delta, and others. Typically, table saw 50 consists of an upper working or cutting surface 60, supported by a frame (not shown). Table saw 50 usually has a guide (known in the trade as a “rip fence”) 80, spaced from rotary blade 70. Blade 70 is normally powered by an electrical motor (not shown), mounted underneath cutting surface 60 to the frame (not shown) of the table saw 50. Blade 70 may be mounted generally longitudinally for rotation about a fixed rotational axis and has a cutting portion that extends through a narrow opening 72 in the table surface 60, above upper working surface 60. However, in some embodiments, blade 70, while being still oriented longitudinally, can have its angle of pitch adjusted from 90 degrees to the work surface, so that an angled cut can be made in a work piece. However, if the pitch angle is changed, the actual transverse displacement of the cutting portion of the blade is relatively small.

Rip fence 80 is mounted longitudinally on upper surface 60 between a pair of transversely oriented end rails 61. Rip fence 80 can slide transversely on rails 61 and typically will have a locking mechanism (not shown) that can be employed to hold rip fence 80 in a specific transverse position on rails 61 and work surface 60. Rip fence 80 provides a robust and rigid barrier along which an edge of a work piece (for example, a piece of wood or the like) can be guided. Rip fence 80 ensures that the cuts being made to the work piece (not shown in FIGS. 1-3) are straight and accurate. Rip fence 80 may also serve to deflect some of the wood debris propelled from the saw blade 70 and prevent such debris from being scattered beyond the rip fence.

In this embodiment shown in FIGS. 1, 2 and 3, rip fence 80 consists of a rectangular vertical wall 84 that extends upwards from the surface of the table surface 60 and a rectangular base plate portion 86 connected thereto. Both wall 84 and base plate 86 may span all or substantially all of the length of surface 60. Rails 61 pass through apertures in an end portion 80a of rip fence 80, and the apertures permit end portions 80a to slide on rails 61.

Thus rip fence 80 is configured so that its transverse position on working surface 60 can be adjusted, thus altering its position in relation to blade 70. This allows the operator to provide different cutting positions for a work piece in relation to blade 70.

Oriented generally parallel to rip fence 80, and positioned on the opposite side of blade 70, is a longitudinally extending, wedged shaped channel 82. Received in channel 82, are sliding connector blocks 83 having dove-tail connection portions 85 received in the channel 82. Blocks 83 are held in channel 82 by the connector portions 85, but are movable longitudinally by sliding along the channel 82. A locking mechanism such as a screw down lock screw (not shown) can be provided to lock blocks 83 in a particular longitudinal position along channel 82. Secured to blocks 83 are so-called feather guides 87, which are known in the art. Feather guides comprising angled members 91, which have end portions formed into a series of fingers. As will become evident, and as is known, feather guides apply lateral pressure toward rip fence 80 on a work piece during the cutting operation. This assists in maintaining the positioning of a work piece that is positioned between the feather guides and rip fence 80. Feather guides 91 assist in pushing work piece against rip fence 80, thus further stabilizing the work piece during cutting by blade 70. The angled orientation forward in the direction of movement of the work piece of the fingers will assist in reducing the chance of “kick-back” of the work piece during cutting.

Turning now to saw guard 10, as shown in FIGS. 1, 2, and 3, positioned above blade 70 is a protective portion 20 forming part of saw guard 10. Protective portion 20 has several components including a cover plate 21. Cover plate 21 is preferably a generally rectangular thin plate member, made from a transparent and shatter proof or shatter resistant material. Although not necessary, it is desirable that cover plate be formed as one continuous plate, having no medial gaps of apertures.

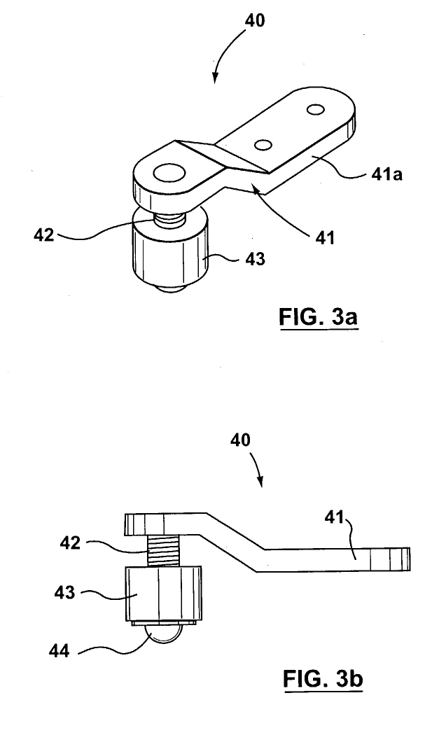

Cover plate 21 has dimensions which provide suitable protective coverage above saw blade 70, throughout the movement of cover plate 21, as hereinafter described. In this regard, distance X (see FIG. 3) between front edge 21b and the leading cutting edge of blade 70 will change, a minimum distance should be maintained throughout the cutting operation. This distance will ensure that if a person's hand accidentally protrudes in the gap under cover plate 21, that person's arm will contact leading edge 21b of the plate before the tips of their fingers contact blade 70. Thus the contact with leading edge 21b will act as a warning they are in danger. If cover plate 21 if positioned about 4 inches above surface 60, a minimum distance of about 8 to 10 inches will be suitable

Cover plate 21 is supported above working surface 60 to provide a vertical displacement above the top of saw blade 70. The gap between surface 60 and the bottom surface of cover plate 21 typically will be large enough to allow work pieces to pass underneath cover plate 21, and thus be cut by blade 70.

As can be seen in FIGS. 1, 2, and 3, cover plate 21 has a longitudinal side edge 21a that in this embodiment, generally abuts along its length, vertical wall 84 of rip fence 80. As clearly illustrated in FIG. 3, cover plate 21 has a slanted leading edge portion 22 (which may be slanted at about a 45° angle) on leading edge 21b, located at the leading corner of the cover plate 21 that is adjacent to vertical wall 84. The orientation of edge 22 allows an operator to more easily move aside cover plate 21 particularly when using a push stick (not shown in FIGS. 1-3). The slanted edge 22 allows a push stick to be easily directed to pass between the rip fence 80 and side edge 21a of cover plate 21 while pushing forward a work piece towards and past the saw blade 70.

Protective portion 20 has several other components connected directly or indirectly to cover plate 21. Extending vertically downwards from the edge 21b of cover plate 21, opposite the edge 21a, is a vertical side wall 24. Extending inwardly at a right degree angle from the bottom edge of protective side wall 24 is a base plate section 26. Extending inwardly and upwardly, which may be at an angle of approximately 30° from the longitudinal edge of base section 26 and joined thereto, is an upwardly slanted wall section 28. Wall sections 24 and 28 and base section 26 are all preferably the same length as cover plate 21. The sloping of wall section 28 assists in providing structural stability to protective portion 20.

Extending inwardly and horizontally from the longitudinal edge of slanted wall section 28 is a lower, end plate section 29. Lower plate section 29 may be bolted or otherwise structurally secured to cover plate 21 to further enhance the structural stability of cover portion 20.

Like cover plate 21, the other parts of protective portion 20, namely vertical side section 24, base section 26, slanted section 28 and lower plate section 29 can also made of a suitable transparent or semi-transparent material such as a suitable clear, rigid plastic like a suitable polycarbonate. It is important that an operator be able to see through at least cover plate 21 when performing a cutting operation so that the cutting of the work piece by the blade is visible.

Additionally, and as may be surmised from the figures, cover plate 21, vertical side section 24, base section 26, slanted section 28 and end section 29 may be integrally formed as a single piece, from one type of material. Such an integrally formed structure can preferably be manufactured using known injection molding or extrusion methods and machines, or other known techniques and machines for manufacturing integral structures. Alternatively, the various sections comprising protective portion 20 may be manufactured separately and then fastened to each other using glue, screws and bolts, and/or other conventional fastening means.

With reference to FIGS. 1, 2, 3, 3a and 3b, attached to the upper surface, at each longitudinal end of base section 26 is a glide bearing generally designated 40. Glide bearing 40 consists of a supporting arm 41 having one end portion 41a adapted for mounting to base section 26 with bolts, screws of other known connection mechanisms. Glide bearing 40 also has a shaft 42 supporting housing 43. Extending downwards through a downward facing opening in housing 43 is a freely rotating spherical ball 44. Ball 44 is mounted in housing 43 for freely rotating movement. For example, ball 44 may be surrounded by small ball bearings that are positioned around ball 44, between ball 44 and the inner wall of housing 43. Glide bearings 40 are used to support a significant proportion of the weight of the protective portion 20 on work surface 60 and help facilitate easy, pivoting transverse movement of the protective portion 20, as described hereinafter.

Saw guard 10 is configured for lateral, pivoting movement towards and away from rip fence 80. The lateral, pivoting movement is achieved by providing a pair of spaced, equal length arms 30a and 30b. Arm 30a is pivotally mounted with a conventional bolt hinge mechanism at one end at C to a part 62 of the frame of table saw 10. At the opposite end, arm 30a is affixed to the bottom of a vertical rod 31a, which extends vertically through an aperture in base 26 at B to connect to arm 30a. Rod 31a will not rotate relative to arm 30a, but it can rotate about a vertical, longitudinal axis in the aperture in base 26, relative to base 26 and the rest of protective portion 20.

Likewise, arm 30b is pivotally mounted with a conventional bolt hinge mechanism at one end at D to part 62 of the frame of table saw 10. At its opposite end, arm 30b is affixed to the bottom of a vertical rod 31b, which extends vertically through an aperture at A in base 26 to connect to arm 30b. Rod 31b will not rotate relative to arm 30b, but can rotate about a vertical longitudinal axis in the aperture in base 26, relative to base 26 and the rest of protective portion 20.

Since the weight of protective portion 20 may be partially carried by arms 30a, 30b, washers can be provided between arms 30a, 30b and the lower surface of base section 26, to assist the arms in rotation relative to base 26.

At its upper end, rod 31a passes through and rotates within, an aperture at E in cover plate 21. The upper end of rod 31a is fixedly connected to the upper end of a secondary support arm 32a. Arm 32a thus has one end secured for pivoting movement at E, with rod 31a. The opposite end of rod 32a is fixedly attached at a medial position on arm 30a.

Likewise, at its upper end, rod 31b passes through and rotates within, an aperture F in cover plate 21. The upper end of rod 31b is fixedly connected to the upper end of a secondary support arm 32b. Arm 32b thus has one end secured for pivoting movement at F, with rod 31b. The opposite end of rod 32b is fixedly attached at a medial position on arm 30b.

Rods 31a, 31b are threaded at their upper ends and each secured at their upper ends with locking nuts 33a, 33b respectively. These locking nuts however, do not impede rotation of rods 31a, 31b such as by contacting with the upper surface of plate 21.

Each arm 32a, 32b may be generally sloped at angle of approximately 30° to the horizontal arm 30a, 30b (ie. the same angle as side wall sections 28).

This overall construction of arms 30a, 30b, 32a and 32b, attached to rods 31a, 31b, provides for a relatively structurally stable guard 10, that can freely pivot on arms 30a, 32a and 30b, 32b about hinges at C and D. As arms 30a, 32a pivot, this will cause rod 31a to pivot in the apertures in cover plate 21 and base 26. Likewise, as arms 30b, 32b pivot, this will cause rod 31b to pivot in the apertures in cover plate 21 and base 26.

By use of support arms 30a, 32a and 30b, 32b (which are oriented generally parallel to each other), the protective portion 20, and in particular cover plate 21, can be translated laterally in an arc defined by the pivoting movement of the arms 30a, 32a and 30b, 32b about D and C. During such pivoting movement, however, edge 21a of cover plate 21a will remain generally parallel to guide 80.

It will be appreciated that the exact configuration of arms 30 and 32 and rods 31 is not critical for the invention and that many possible shapes and configurations for arms and/or rods may be used to provide the lateral movement like or similar to that described below.

The saw guard 10 is also provided with a self-biasing feature which acts in the direction of the arrow in FIG. 1, for protective portion 20 and in particular cover plate 21. Cover plate 21 is generally biased to a resting position. In some situations the resting position is where arm 30a is in abutment with a stop block 71. In other situations, the arm 30a may not be rotated clockwise sufficiently to reach block 71 and the rest position will be where edge 21a of cover plate 21 is in abutment substantially along its entire length with wall 84 of rip fence 80. In these rest positions, blade 70 is clearly covered from above by cover plate 21.

The self-biasing feature is achieved in the preferred embodiment as follows. As can be seen in FIG. 3, fixedly mounted to rod 31a, and fastened beneath the bottom surface of cover section 21, is a lever arm 35. Lever arm 35 has one end fixedly attached to vertical rod 31a, and so rotates with rod 31a. The other end of lever arm 35 has its end connected to one end of an extended tension spring 34. The other end of spring 34 is secured to vertical rod 31a. The extended spring which exerts tension forces at its connection points, thus co-operates with lever arm 35 to exert a torque force acting on cover plate 21, that tends to rotate cover plate 21 in the direction of the arrow in FIG. 1, to a biased position against rip fence 80.

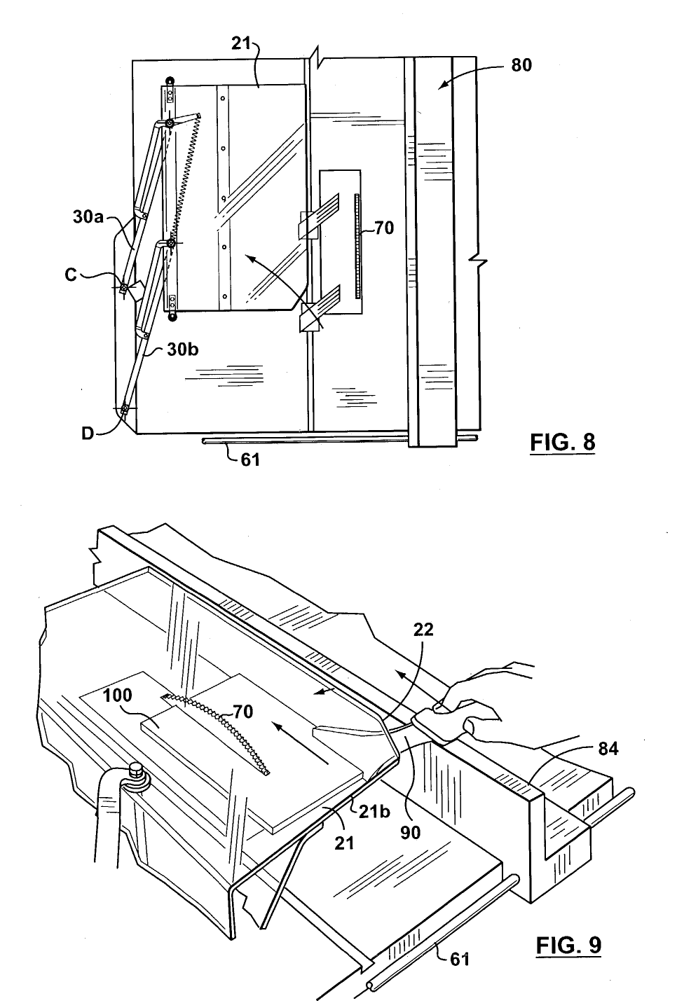

FIG. 8 shows for illustrative purposes only, protective portion 20 displaced by a displacing force and torque, acting against the biasing force and torque, so that saw blade 70 is completely exposed (ie. uncovered by plate 21). However, in normal operation of table saw 50, there would not be a need to displace protective portion 20 to such a degree. This degree of displacement would however facilitate for example, maintenance of the table saw 50.

It should also be noted, that the more displaced the cover plate 21 is from its resting position in a counter-clockwise direction, the greater the extension of the spring 34, due to movement of lever arm 35 relative to rod 31a. Therefore, the greater the extension of spring 34, the greater the tension force and resulting restoring force and torque acting on plate 21. This progressive increase in resistance to displacement of cover plate 21, will inhibit the plate 21 being displaced to such an extent that the cover plate uncovers the blade 70.

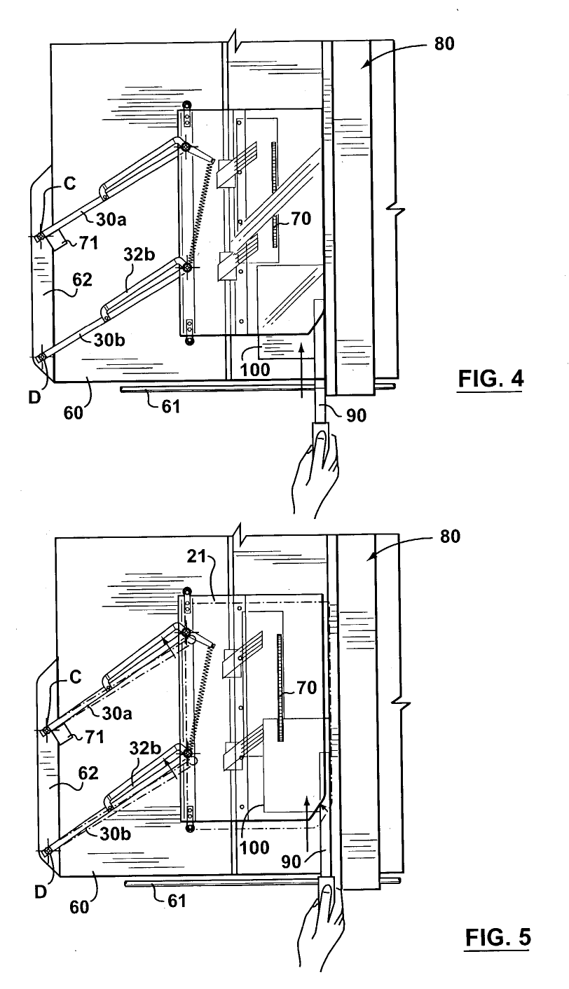

FIGS. 4-7 shows saw guard 10 in operation. FIG. 4 is a top plan view of the saw guard 10 in a resting position above saw blade 70. As can be seen in FIG. 4, a separate push member such as push stick/rod 90 is preferably used to push wood material 100 forward and towards saw blade 70 so that the blade performs the desired cut on the work piece. Push stick 90 can be any device or contraption that allows the operator to push the work piece forward, while providing a reasonably safe distance between the operator's hand and the work piece. As shown in FIG. 9, typically, push stick 90 will consist of a base portion to engage the work piece 100 and push it forward; a vertical middle portion having a height that preferably exceeds the vertical distance between the surface table 60 and cover section 21. Push stick 90 also has a gripping handle. In the preferred embodiment shown in FIG. 9, the base portion is slotted to provide a more secure and stable pushing force applicator for the work piece.

Push stick 90 should have a vertical height that exceeds the vertical distance between the top of the cover section 21 and the surface table 60, so that the operator's hand, can grip the handle portion of the push stick located above the cover plate 21. A safe distance between the operator's hand and blade 70 can thus be maintained during the entire cutting operation on a work piece. Push stick 90 may also be made of a material that is soft enough that it won't “kick-back” or shatter if it accidentally makes contact with blade 70. An example of such a material is soft plywood.

FIG. 5 shows a subsequent view to the view shown in FIG. 4 of the saw guard 10 in operation. As can be seen in FIG. 5, the work piece 100 has reached saw blade 70, and a cut is underway. The dimensions of the wood piece 100 are such that work piece 100 has been moved completely under cover section 21. If saw guard 10 were immovable, it would not be possible to continue pushing the wood material 100 using the push stick 90 since the cover plate of such a saw guard would impede the movement of the push stick. However, cover plate 21 is movable. Accordingly, when push stick 90 engages the slanted portion 22 of leading edge 21b of cover plate 21, the push stick applies a force against the cover section 21 that exceeds the biasing force caused by spring 34. However, the biasing force can be relatively small and does not usually create such a torque and force that the push stick is forced laterally against rip fence 80 with a great deal of force. It should also be noted that it is useful if the operator can feel the reaction force of the blade 70 on the work piece being cut, while making the cut. Therefore, the biasing force may not be so large that when the operator is pushing against cover plate 21, the biasing force interferes with the operator's ability to feel the cutting operation taking place

The force exerted by the push stick causes the two arms 30a, 30b to start pivoting counterclockwise about C and D respectively. Consequently, the radial pivoting of the two arms 30a, 30b results in a small lateral and counter clockwise pivoting movement of the protective portion 20 with respect to the table surface 60.

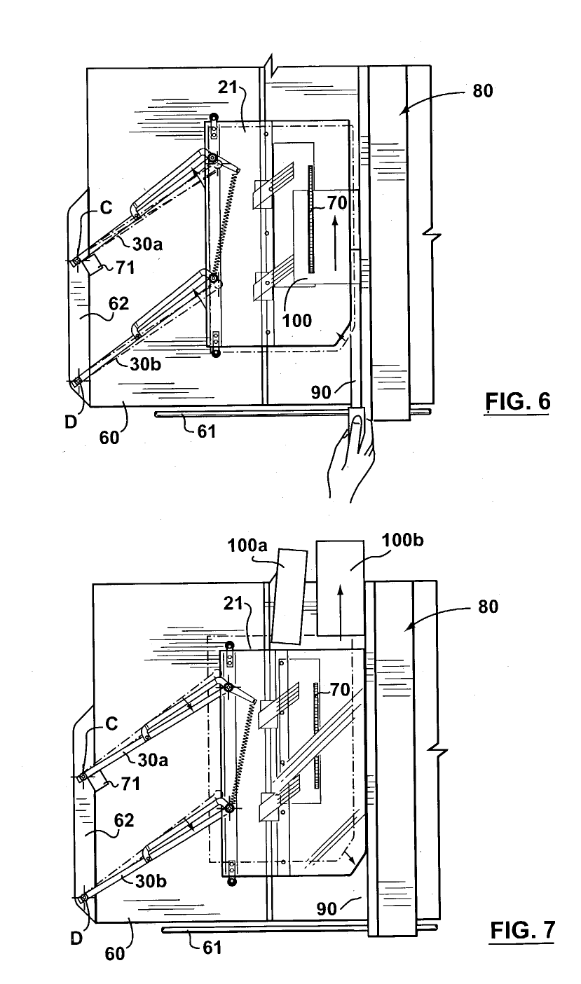

FIG. 6 shows a subsequent view to the view shown in FIG. 5. As push stick 90 continues to engage edge 22 of cover plate 21, push stick 90 gradually slides forward along and follows edge 22, which will be the path of least resistance for push stick 90. The force exerted by push stick 90 on cover section 21 (and by extension, on the entire saw guard 10) continues to cause the arms 30 to pivot counterclockwise, thus resulting in further lateral and forward displacement of the protective portion 20 with respect to the table surface 60.

Eventually, when the lateral displacement of the cover plate 21 from the vertical wall 84 of rip fence 80 reaches the width of the middle vertical section of the push stick 90, the middle vertical section of the push stick will fit exactly, and slide, into the space formed between the vertical wall 84 and the edge 21a. At that point, push stick 90 will no longer exert a force on cover plate 21 that will cause any further significant displacement of cover plate 21. As the operator continues to direct push stick 90 forward, push stick 90 will remain in the space formed between cover section 21 and vertical wall 84.

As can further be seen in FIG. 6, while push stick 90 advances in the space formed between cover plate 21 and vertical wall 84, cover plate 21 continues to cover saw blade 70. Thus, should the operator's hand slip while guiding the push stick forward, the operators' hand should harmlessly hit leading edge 21b of cover plate 21 before it reaches anywhere near blade 70. It will also be appreciated that as cover section 21 continues to entirely cover the saw blade 70 from above, wood debris propelled from the saw blade will be prevented from hitting the operator's upper body (particularly the operator's head), and for the most part will be scattered in the area substantially enclosed by the protective portion 20.

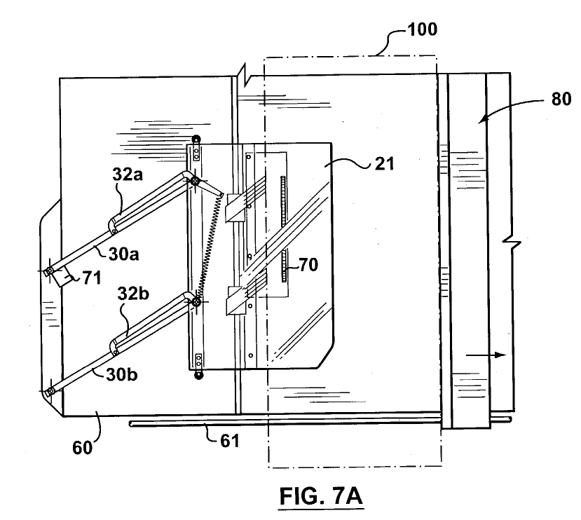

FIG. 7 shows a subsequent view to the view in FIG. 6, at which point the cut to work piece 100 into two pieces 100a and 100b has been completed. After push stick 90 finishes pushing the wood material past the saw blade 70, push stick 90 preferably continues movement forward until it exits from the space formed between cover plate 21 and vertical wall 84 near the far side edge of table surface 60. In some embodiments, the push stick 90 can simply be pulled upwards. In any case, once push stick 90 is removed, spring 34 urges protective portion 20 (and with it the entire saw guard 10 assembly) to return to cover plate 21 to its initial resting position in which cover section 21 abuts vertical wall 84. The operator may then go to the other end of the cutting table surface 60 where processed work pieces 100a and 100b cut from work piece 100 were left, and safely remove the wood pieces.

During the entire cutting process, the cover plate does not prevent appropriate pushing movement with the push stick. Additionally, the cover plate movement does not interfere with, and can accommodate the use of the optional feather guides.

It is also important to note that blade 70 is typically left rotating for extended periods of time, and the biasing of cover plate 21 ensures that during that time, when no operator is cutting a work piece, the cover plate will remain biased against guide 80.

Although guard 10 is particularly adapted for use with a push stick, guard 10 also is useful where the pushing member is an operator's appendage, as the cover plate will direct the pushing appendage down the side edge 21a, reducing the risk to an operator. However, this should only be done where the width of the cut piece 100b from the blade is at least 5 inches so the hand or fingers used to push the work piece will be far enough to the right side of surface 60 to be well clear of the blade

With reference to FIG. 7a, table saw 50 is shown with rip fence 80 in an alternate transverse position that can be used when cutting a wider work piece 1100. In this configuration, the rest position of cover plate 21 is determined by the abutment of arm 30a against stop block 71.

The foregoing described only a preferred embodiment and modifications and variations will readily become apparent to those of ordinary skill in the art without departing from the scope of the invention as defined by the claims hereinafter.

I claim:

1. A guard for a table saw, said table saw comprising:
a. a table having an upper working surface;
b. a rotating blade mounted to the table and configured to cut a work piece that is moved past it on said working surface;
said guard comprising:
i. a cover member positioned above said working surface and said rotating blade, said cover member providing a gap between a lower surface of said cover member and said working surface to permit a work piece to pass there through to be cut by said rotating blade;
ii. at least one support member for supporting said cover member in said position, said at least one support member being adapted to facilitate lateral movement of said cover member between a first position and a second working position, said lateral movement being generally parallel to said working surface and said movement being between a first position wherein said cover member covers said rotating blade from above and blocks a pushing member from passing said cover member, and a second position wherein said cover member no longer blocks said pushing member from passing said cover member wherein said cover member still covers said rotating blade from above, in said second position.

2. A guard as claimed in claim 1 wherein said cover member is configured generally as a cover plate.

3. A guard as claimed in claim 2 wherein said cover plate is oriented generally parallel to said working surface of said table.

4. A guard as claimed in claim 3 wherein said rotating blade is visible from above, beneath said cover plate at said first and second positions.

5. A guard as claimed in claim 4 wherein said cover plate is made from a transparent material.

6. A guard as claimed in claim 5 wherein said material is shatter-proof or shatter resistant.

7. A guard as claimed in claim 2 wherein said table saw further comprises a guide member positioned above said working surface, and extending longitudinally, said guide member being spaced from said rotating blade, said guide member adapted for guiding the movement of a work piece on said upper working surface to facilitate cutting by said rotating blade.

8. A guard as claimed in claim 7 wherein in said first position of said cover plate, a side edge of said cover plate is positioned in abutment with said guide member to block a pusher member from passing between said cover plate and said guide member, and in said second position said cover plate is positioned to provide a space between which said pusher member can pass between said cover plate and said guide member.

9. A guard as claimed in claim 8 wherein said pusher member is an appendage.

10. A guard as claimed in claim 8 wherein said pusher member is a push rod.

11. A guard as claimed in claim 8 wherein said cover plate has a leading edge, and said leading edge has a slanted portion and a remaining portion, said slanted portion being angled away from said remaining portion toward said blade and intersecting said side edge, whereby a pushing member forced against said slanted portion will slide along said slanted portion to said side edge.

12. A guard as claimed in claim 2 further comprising a position restoring mechanism providing a restoring force on said cover plate operable such that when said cover plate is displaced by an external force from said pusher member, from said first position to said second position, when said external force is removed, said restoring mechanism will return said cover plate to said first position.

13. A guard as claimed in claim 12 wherein said restoring force permanently biases said cover plate toward said first position.

14. A guard as claimed in claim 1 wherein said cover member is made from a transparent material that permits an operator of said machine to see said work piece and said rotating blade there through.

15. A guard as claimed 14 wherein said material is shatterproof or shatter resistant.

16. A guard as claimed in claim 2 wherein said at least on support member comprises a support frame comprising a pair of pivoting arm members interconnected to said cover plate, said pivoting arm members adapted to provide pivoting lateral movement of said cover plate, said pivoting lateral movement being generally parallel to said working surface between said first and second positions.

17. A guard as claimed in claim 8 wherein said at least one support member comprises a support frame comprising a pair of pivoting arm members interconnected to said cover plate, said pivoting arm members adapted to provide pivoting lateral movement of said cover plate, said pivoting lateral movement being generally parallel to said working surface between said first and second positions and being between said first position wherein said cover plate is in abutment with said guide member and covers said rotating blade, and said second position wherein said cover plate is spaced from said guide member but covers said cutting portion of said blade.

18. A guard as claimed in claim 2 further comprises a longitudinally extending side wall portion interconnected to said cover plate and extending downwardly from said cover plate toward said upper surface, said blade being disposed between said guide member and said side wall portion.

19. A guard as claimed in claim 18 wherein said table saw further comprises at least one guide member positioned beneath said cover plate and between said side wall and said blade.

20. A guard as claimed in claim 18 wherein further comprising a longitudinally extending slanted wall portion interconnected to said side wall portion and extending inwardly and upwardly to said cover plate.

21. A guard as claimed in claim 2 further comprising a moving support member for supporting said cover plate above upper surface, said support member movable on said upper surface for assisting in the movement of said cover plate between said first position and said second position.

22. A table saw comprising:
a. a table having an upper working surface;
b. a rotating blade configured to cut a work piece that is moved past it on said working surface;
c. a guard comprising:
i. a cover member oriented generally parallel to said working surface of said table and being positioned above said working surface and said rotating blade, said cover member providing a gap between a lower surface of said cover member and said working surface to permit a work piece to pass there through to be cut by said rotating blade;
ii. at least one support member for supporting said cover member in said position, said at least one support member being adapted to facilitate lateral movement of said cover member between a first position and a second position, said lateral movement being generally parallel to said working surface and said movement being between a first position wherein said cover member covers said rotating blade and blocks a pushing member from passing said cover member, and a second position wherein said cover plate no longer blocks said pushing member from passing between said cover member but at which said cover plate still covers said rotating blade.

23. A table saw as claimed in claim 22 wherein said cover member is configured generally as a cover plate.

24. A table saw as claimed in claim 23 wherein said cover plate is oriented generally parallel to said working surface of said table.

25. A table saw as claimed in claim 24 wherein said rotating blade is visible from above, beneath said cover plate at said first and second positions.

26. A table saw as claimed in claim 25 wherein said cover plate is made from a transparent material.

27. A table saw as claimed in claim 26 wherein said material is shatter-proof or shatter resistant.

28. A table saw as claimed in claim 23 wherein said table saw further comprises a guide member positioned above said working surface, and extending longitudinally, said guide member being spaced from said rotating blade, said guide member adapted for guiding the movement of a work piece on said upper working surface to facilitate cutting by said rotating blade.

29. A table saw as claimed in claim 28 wherein in said first position of said cover plate, a side edge of said cover plate is positioned in abutment with said guide member to block a pusher member from passing between cover plate and said guide member, and in said second position said cover plate is positioned to provide a space between which said pusher member can pass between said cover plate and said guide member.

30. A table saw as claimed in claim 29 wherein said pusher member is an appendage.

31. A guard as claimed in claim 29 wherein said pusher member is a push rod.

32. A guard as claimed in claim 23 wherein said cover plate has a leading edge, and said leading edge has a slanted portion and a remaining portion, said slanted portion being angled away from said remaining portion toward said blade and intersecting said side edge, whereby a pushing member forced against said slanted portion will slide along said slanted portion to said side edge.

33. A table saw as claimed in claim 23 further comprising a position restoring mechanism providing a restoring force on said cover plate operable such that when said cover plate is displaced by an external force from said pusher member, from said first position to said second position, when said external force is removed, said restoring mechanism will return said cover plate to said first position.

34. A table saw as claimed in claim 33 wherein said restoring force permanently biases said cover plate toward said first position.

35. A table saw as claimed in claim 22 wherein said cover member is made from a transparent material that permits an operator of said machine to see said work piece and said rotating blade there through.

36. A guard as claimed 35 wherein said material is shatterproof or shatter resistant.

37. A table saw as claimed in claim 22 further comprising a guide member positioned above said working surface, and extending longitudinally, said guide member being spaced from said rotating blade, said guide member adapted for guiding the movement of a work piece on said upper working surface to facilitate cutting by said rotating blade, and wherein in said first position of said cover plate, a side edge of said cover plate is in abutment with said guide member to block said pushing member from passing between cover plate and said guide member, and said second position providing a space between which said pusher member can pass between said cover plate and said guide.

38. A method for cutting materials using a table saw, and using a saw guard comprising of a substantially planar protective section positioned above the saw blade of said table saw, and of a retracting mechanism comprising of an arm attached to said protective section and a spring attached to said protective section and biased to return said protective section to said protective section's original position, said method comprising:
a) placing a piece of said material along a rip fence such that said material abuts said rip fence;
b) pushing said material along said rip fence towards said saw blade using a push stick, wherein said push stick has a vertical height larger than the vertical distance between the protective section of said saw guard and the upper surface of said table saw;
c) engaging said protective section of said saw guard using said push stick, thereby causing said arm attached to said protective section to pivot laterally, thereby causing said protective section to be displaced away from said rip fence and forming a narrow gap between said protective section and said rip fence, while maintaining said protective section above said saw blade;
d) sliding said push stick in the said gap formed between said protective section and said rip fence, and continuing to push said material in the direction of the saw blade; and
e) upon completion of the cut, removing said push stick from said gap formed between said rip fence and said protective section of said saw guard, thereby allowing said retracting mechanism to return said protective section to said protective section's original position.

39. A method for cutting materials using a table saw having a saw blade, and using a saw guard comprising a protective member positioned above the saw blade of said table saw, said method comprising:
a) placing a piece of said material along a longitudinally oriented guide member such that said material abuts said rip fence;
b) pushing said material longitudinally with a push stick along said guide member towards said saw blade; and
c) moving said protective member laterally while maintaining said protective member above said saw blade by longitudinal engagement of said push stick with an edge of said protective member, to permit said push stick to pass said protective member said protective member covering said saw blade from above during said pushing by said push stick.

40. A guard for a table saw, said table saw comprising:
a. a table having an upper working surface;
b. a rotating blade mounted to the table and configured to cut a work piece that is moved past it on said working surface;
said guard comprising a cover plate positioned above and oriented generally parallel to said working surface, and being positioned above said rotating blade, said cover plate providing a gap between a lower surface of said cover plate and said working surface to permit a work piece to pass there through to be cut by said rotating blade and at least one support member for supporting said cover plate in said position.

41. A guard as claimed in claim 40 wherein said rotating blade is visible from above, beneath said cover plate.

42. A guard as claimed in claim 40 wherein said cover plate is made from a transparent material.

43. A guard as claimed in claim 42 wherein said material is shatter-proof or shatter resistant.
